(19) United States
(12) Patent Application Publication
(10) Pub. No.: US 2023/0373879 A1
(43) Pub. Date: Nov. 23, 2023

(54) Fully bio-based coating material for polyurethane controlled release fertilizer and polyurethane controlled release fertilizer

(71) Applicant: Maoshi Agricultural Technology Co., Ltd, Chizhou (CN)

(72) Inventors: Chenghu Zhong, Chizhou (CN); Zimian Zhong, Chizhou (CN); Ligan Zhang, Chizhou (CN); Cun Liu, Chizhou (CN)

(21) Appl. No.: 18/227,167

(22) Filed: Jul. 27, 2023

(30) Foreign Application Priority Data
Apr. 28, 2023 (CN) 2023104788785

(51) Int. Cl. C05G 5/30; C08G 18/73; C08G 18/58

(52) U.S. Cl. CPC C05G 5/37; C08G 18/73; C08G 18/58; C08G 2150/00

(57) ABSTRACT

A curing agent isocyanate of a fully bio-based coating material for a polyurethane controlled release fertilizer is a bio-based 1,5-pentane diisocyanate compound. The bio-based 1,5-pentane diisocyanate compound is a compound of a bio-based 1,5-pentane diisocyanate monomer and its polymer, or a compound of different bio-based 1,5-pentane diisocyanate polymers. The bio-based PDI (1,5-pentane diisocyanate) polymer comprises a bio-based PDI trimer and its derivatives, a bio-based PDI tetramer and its derivatives, and other bio-based PDI multimers and their derivatives, which are derived from bio-based materials such as glucose and lysine. The mass percentage of bio-based materials in all raw materials is in a range of 65% to 71%. The coating material is prepared by cross-linking the bio-based polyol and the bio-based 1,5-pentane diisocyanate compound.

### CROSS REFERENCE OF RELATED APPLICATION

The present invention claims priority under 35 U.S.C. 119(a-d) to CN 202310478878.5, filed Apr. 28, 2023.

### BACKGROUND OF THE PRESENT INVENTION

### Field of Invention

The present invention relates to the technical field of coating material for controlled release fertilizer, and more particularly to a fully bio-based coating material for a polyurethane controlled release fertilizer and a polyurethane controlled release fertilizer.

### Description of Related Arts

With the development of agricultural science and technology, the fertilizers used in agricultural production have also changed, and new fertilizers have appeared, such as slow-release fertilizers, liquid fertilizers, and gas fertilizers. Among them, slow controlled release fertilizers are the traditional fertilizer granules (such as: special compound fertilizers for crops or urea) coated with a special film with controlled release function; according to the nutrient demand of crop growth, the nutrient release speed and the release amount are controlled to make the nutrient release speed consistent with the crop demand. Therefore, slow controlled release fertilizers are able to supply effective nutrients synchronously according to the law of crop growth, so that the effective utilization rate of fertilizer nutrients is greatly improved, and the utilization rate of fertilizers is improved. In addition, the fertilizer coating slowly releases nutrients by absorbing water to generate pressure, which is able to reduce the volatilization of nutrients and the loss of nutrients when they are exposed to the rain, thus improving the utilization efficiency of fertilizers.

The core of the controlled release technology of slow controlled release fertilizers coating lies in the coating material and the corresponding additives. By adjusting the formula and preparation process of the coating material, the physical properties such as water vapor transmission rate, mechanical strength, elongation and wear resistance are able to be adjusted. Materials with different cross-linking densities and crystallization properties are obtained by different formulas, so that the water vapor transmission rate and the fertilizer core aqueous solution permeability of the coating material, thereby achieving the purpose of controlling the release of nutrients. In addition, the nutrient release of controlled release fertilizers is also limited by temperature, moisture and other conditions. According to the environmental conditions such as crop planting soil and its nutrient needs, the release time and the release peak period of the nutrient release of controlled release fertilizers are able to be adjusted. Therefore, the slow controlled release fertilizer is an intelligent and environmentally friendly new fertilizer.

With the continuous development of agricultural production mode, controlled release fertilizers are urgently needed for high yield and efficient production of field crops. Although the coating technology continues to improve, it is still limited in cost and product type, and its application in field crops is unable to be widely promoted. The coating materials are mainly sulfur, polyethylene, alkyd resin and polyurethane. Among them, compared with other coating materials, polyurethane coating materials have the advantages of high strength, good elasticity, excellent temperature resistance, fine and uniform pore size and easy biodegradation. Therefore, the research and development of polyurethane coating materials have become the main development direction of coating materials for controlled release fertilizers in recent years.

The existing polyurethane coating materials are mainly prepared by the reaction of polyols with crude MDI (diphenylmethane diisocyanate). Among them, polyols are divided into polyesters and polyethers. Polyesters are prepared by the reaction of binary acid or anhydride with diol or polyhydric alcohols. Polyethers are prepared by performing the ring-opening polymerization on polyhydroxyl-alcohol as an initiator with ethylene oxide and propylene oxide. Compared with polyester polyurethane materials which are not easily hydrolyzed, polyether polyurethane materials are slow in biodegradation and relatively high in cost. Therefore, polyester materials become the preferred option in the polyurethane coating materials for controlled release fertilizers.

The Chinese patent document CN 107383347 B discloses a bio-based aromatic polyester polyol for controlled release fertilizers and its applications. The fatty acid, diethylene glycol, glycerol, etc., are inhaled into the reaction kettle in vacuum in order; and then terephthalic acid, phthalic anhydride and trimethylol propane are put into the reaction kettle through the solid feed port for perform the esterification reaction, so as to obtain the bio-based aromatic polyester polyol. The bio-based aromatic polyester polyol, the castor oil and the epoxy soybean oil are added into the mixing tank according to a weight ratio of 90:5:5 and are stirred evenly for 5-10 minutes, the temperature is controlled at about 30° C. to obtain the A material. The crude MDI is put into the mixing tank and is stirred evenly, the temperature is controlled at about 30° C. to obtain the B material. The epoxy soybean oil in this technical scheme is only used as a plasticizer additive, and does not participate in the chemical reaction process. The bio-based content in the Chinese patent is less than 50%, and at the same time, the crude MDI used in the Chinese patent belongs to the petroleum-based isocyanate, which is a non-biological material. Petrochemical raw materials are high in cost and are non-renewable resources. Therefore, the bio-based aromatic polyester polyol disclosed by the Chinese patent is not a fully bio-based coating material, which is costly and non-renewable.

The Chinese patent document CN 113105604 B discloses a bio-based polymer coating material, a coated controlled release fertilizer and a preparation method thereof. The bio-based polymer coating material comprises 50-70% of hydroxyl-containing component and 30-50% of isocyanate 30-50% by weight. The hydroxyl-containing component comprises 50-90% of hydroxy-terminated prepolymer, 2-10% of additives, 7-50% of polyol and 1-10% of small molecule chain extender. The hydroxy-terminated prepolymer is prepared by reacting 80-100% of biomass liquefaction products with 0-20% of isocyanate. The curing agent isocyanate used in this technical scheme is also from petroleum base, which is high in cost and is a non-renewable resource, and does not belong to the fully bio-based coating material. Moreover, the bio-based polymer coating material disclosed by the Chinese patent has many kinds of raw materials, complex preparation methods and high cost.

Bio-based materials are new materials made by biological, chemical and physical methods using renewable biomass as raw materials, including common crops, other plants, grains, legumes, straw, bamboo and wood powders. With the emergence of bio-based materials, they are able to simultaneously meet the needs of low-carbon environmental protection and meet the diversified consumer needs of the market. Therefore, bio-based materials have become a new choice in the current carbon-neutral era. Bio-based materials have many advantages such as green and low-carbon, energy saving and environmental protection, renewable raw materials, and have good biodegradation characteristics, and are able to be used in a wide range of applications.

Therefore, the present invention intends to develop a bio-based coating material for polyurethane controlled release fertilizers, which is suitable for mass production with high biocompatibility, high biodegradability, good environmental protection and safety performance and low cost, and will have great significance for the development of controlled release fertilizer industry in China.

### SUMMARY OF THE PRESENT INVENTION

A technical problem to be solved of the present invention is to provide a fully bio-based coating material for a polyurethane controlled release fertilizer and a polyurethane controlled release fertilizer. The coating material is prepared by cross-linking the bio-based polyol and the bio-based 1,5-pentane diisocyanate compound. It has high biocompatibility, high biodegradability, good environmental protection and safety performance, good wear resistance and compression resistance, and low cost. It is suitable for mass production.

To solve the above technical problem, the present invention provides technical schemes as follows.

Firstly, the present invention provides a fully bio-based coating material for a polyurethane controlled release fertilizer, wherein:
a curing agent isocyanate of the coating material is a compound;
a bio-based 1,5-pentane diisocyanate compound is a compound of a bio-based 1,5-pentane diisocyanate monomer and its polymer, or a compound of different bio-based 1,5-pentane diisocyanate polymers.

Further, an average functionality of the bio-based 1,5-pentane diisocyanate compound is in a range of 2.8 to 3.5, a content of NCO thereof is in a range of 24% to 30%, and a mass percentage of bio-based materials accounts for 65% to 71% of all raw materials.

In the present invention, NCO is an isocyanate group in a chemical material, and the content of NCO is a mass percentage of the isocyanate group (—NCO) in a 100 g of sample.

A chemical structural formula of the bio-based PDI (1,5-pentane diisocyanate) monomer is shown in a formula (I) of

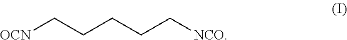

Further, the bio-based PDI (1,5-pentane diisocyanate) polymer comprises a bio-based PDI trimer and its derivatives, a bio-based PDI tetramer and its derivatives, and other bio-based PDI multimers and their derivatives, wherein:

a chemical structural formula of the bio-based PDI trimer is shown in a formula (II) of

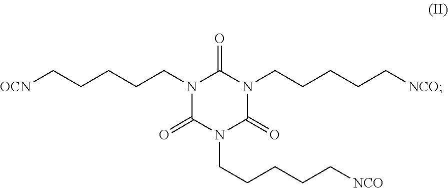

a chemical structural formula of the bio-based PDI tetramer is shown in a formula (III) of

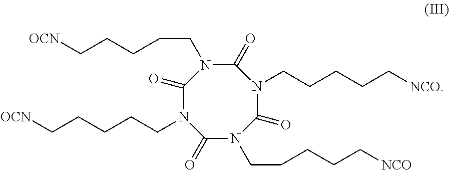

It is able to be understood that compared with the PDI monomer, the PDI polymer has a network chemical structure, so the coating material prepared by the PDI polymer has a higher cross-linking density after film formation.

Further, the bio-based PDI monomer is prepared by a method which comprises steps of preparing 1,5-pentanediamine by fermenting a bio-based material with a bio-enzyme, and performing phosgenation reaction on the 1,5-pentanediamine; the bio-based material is at least one member selected from a group consisting of glucose and lysine;

the bio-based PDI trimer and its derivatives, the bio-based PDI tetramer and its derivatives, and other bio-based PDI multimers and their derivatives are prepared by performing polymerization reaction on the bio-based PDI monomer with a catalyst.

Specifically, Mitsui Chemicals provide a series of products, which are the bio-based PDI monomer Stabio™ PDI, the bio-based PDI trimers Stabio™ PDI D-370N and Stabio™ PDI D-376N, and the bio-based PDI tetramer Stabio™ PDI D-3725N.

Preferably, the compound of the bio-based PDI monomer and its polymer is a compound of the bio-based PDI monomer Stabio™ PDI and the bio-based PDI trimer Stabio™ PDI D-370N, a compound of the bio-based PDI monomer Stabio™ PDI and the bio-based PDI trimer Stabio™ PDI D-376N, or a compound of the bio-based PDI monomer Stabio™ PDI and the bio-based PDI tetramer Stabio™ PDI D-3725N. It is able to be understood that the compound of the bio-based PDI monomer and its polymer is also able to be a compound of the bio-based PDI monomer and other bio-based PDI multimers.

Preferably, the compound of different bio-based PDI polymers is able to be a compound of different bio-based PDI trimers, tetramers and other multimers with different functionalities and/or viscosities, such as a compound of the bio-based PDI trimer Stabio™ PDI D-370N and the bio-based PDI trimer Stabio™ PDI D-376N; or a compound of the bio-based PDI multimers with different degrees of polymerization, such as a compound of the bio-based PDI trimer Stabio™ PDI D-370N or D-376N and the bio-based PDI tetramer Stabio™ PDI D-3725N.

It is able to be understood that the compound provided by the present invention comprises at least two bio-based PDI multimers.

Further, the coating material is prepared by cross-linking the bio-based polyol and the bio-based 1,5-pentane diisocyanate compound, wherein:

a molar ratio of an oxhydryl group in the bio-based polyol to the NCO group in the bio-based PDI compound is in a range of (0.98-1.10): 1; and is preferably, 0.981:1, 0.99:1, 1:1 or 1.1:1; and more preferably, is 1:1.

Further, the bio-based polyol is prepared by performing ring-opening polymerization on epoxidized fatty acid ester, bio-based acid and bio-based alcohol, wherein:

the bio-based acid is lactic acid; and the bio-based alcohol is at least one member selected from a group consisting of glycerol, 1,3-propanediol, 1,4-butanediol, and glycol.

A preparation method of the bio-based polyol comprises steps of:
(1) preparing a lactate polyol intermediate product by performing an esterification reaction on lactic acid, the bio-based alcohol and an esterification catalyst, wherein a molar ratio of an oxhydryl group in the lactic acid to that in the bio-based alcohol is in a range of 4:1 to 8:1; and
(2) performing a ring-opening reaction by adding epoxidized fatty acid ester into the lactate polyol intermediate product in batches for obtaining the bio-based polyol, wherein a mass percentage of the epoxidized fatty acid ester accounts for 15%-20% of a total reactant which consists of the epoxidized fatty acid ester and the lactate polyol intermediate product.

Preferably, the preparation method of the bio-based polyol specifically comprises steps of:
(1) preparing a lactate polyol intermediate product by performing an esterification reaction which comprises steps of adding lactic acid, bio-based alcohol and an esterification catalyst into a reaction kettle, and heating up the reaction kettle to 120-200° C., wherein when an acid value drops below 20 mgKOH/g, the lactate polyol intermediate product is obtained; a molar ratio of an oxhydryl group in the lactic acid to that in the bio-based alcohol is in a range of 4:1 to 8:1; and
(2) performing a ring-opening reaction by adding epoxidized fatty acid ester into the lactate polyol intermediate product at 140-150° C. in batches, wherein a mass percentage of the epoxidized fatty acid ester accounts for 15-20% of a total reactant which consists of the epoxidized fatty acid ester and the lactate polyol intermediate product; due to the ring-opening reaction is an exothermic reaction, a temperature of the reaction is remained at 150-180° C. by controlling an adding speed of the epoxidized fatty acid ester; the temperature of the reaction drops to 140° C. after completing addition of the epoxidized fatty acid ester; maturing the ring-opening reaction by increasing the temperature to 160-180° C.; remaining the temperature at 160-180° C. for 0.5-0.8 hours, and preferably for 0.5 hours; increasing the temperature to 220-260° C., detecting an acid value at 220-260° C.; when the acid value drops below 5 mgKOH/g, decreasing the temperature to 200-230° C.; and performing rectification under vacuum with a vacuum degree in a range of −0.075 to −0.095 MPa till an acid value of a product after rectification drops below 2.0 mgKOH/g and a moisture mass percentage is less than 0.1%, thereby obtaining the bio-based polyol.

Preferably, the mass percentage of the epoxidized fatty acid ester accounts for 15.5-18.5% of the total reactant which consists of the epoxidized fatty acid ester and the lactate polyol intermediate product; and more preferably, the mass percentage is 15.5%, 15.7%, 15.9%, 16%, 16.5%, 16.8%, 16.9%, 17%, 17.2%, 17.3%, 17.5%, 17.8%, 18.0%, 18.2% or 18.5%.

In the preparation method of the bio-based polyol, the lactic acid with low boiling point is introduced into the polyol system for sufficient reaction, so as to ensure that the lactic acid is able to sufficiently react at high hydroxyl value content and to be introduced into the polyol system.

In the present invention, the lactic acid, the glycerol, the 1,3-propanediol, the 1,4-butanediol and the glycol are bio-based products.

The principle of the above preparation method is as follows.

The ring-opening reaction of oxhydryl and epoxy group is as follows.

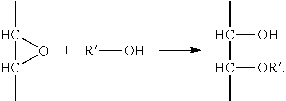

The ring-opening reaction of carboxylic acid and epoxy group is as follows.

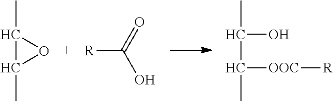

The esterification reaction of oxhydryl and carboxyl is as follows.

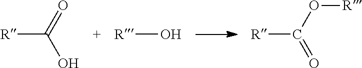

Further, in the step (1), a mass percentage of the esterification catalyst accounts for 0.2-0.8% of a total reactant which consists of the lactic acid, the bio-based alcohol and the esterification catalyst.

Further, in the step (1), the esterification catalyst is an organo-titanate catalyst, an organotin catalyst, calcium oxide or zinc acetate; and preferably, the organo-titanate catalyst is isopropyl titanate or butyl titanate.

Further, the epoxidized fatty acid ester is an epoxide or an ester of a long-chain unsaturated fatty acid with an aliphatic chain of 10 to 24 carbon atoms and at least one ethylene oxide group;

or an epoxide of a long-chain unsaturated fatty oil with an esterified fatty acid chain of 10 to 24 carbon atoms, and the esterified fatty acid chain comprises at least one ethylene oxide group.

Preferably, an epoxy value of the epoxidized fatty acid ester is greater than 6%.

Further, the epoxidized fatty acid ester is an epoxidized fatty oil, an epoxidized unsaturated fatty acid or an epoxidized ester of an unsaturated long-chain fatty acid.

Further, the epoxidized fatty oil is at least one member selected from a group consisting of epoxy soybean oil, epoxy corn oil, epoxy castor oil, epoxy cottonseed oil, epoxy hemp seed oil, epoxy tall oil, epoxy safflower seed oil, epoxy peanut oil, epoxy flaxseed oil, and epoxy rapeseed oil.

Further, the epoxidized unsaturated fatty acid is at least one member selected from a group consisting of 5,6-epoxy decanoic acid, 9,10-epoxy ricinoleic acid, 9,10-epoxy stearic acid, 4,5-epoxy decanoic acid, 9,10-epoxy octadecanoic acid, 9,10-epoxy tetracarboxylic acid, 8,9-epoxy-1-hydroxydecanoic acid, and 9,10-epoxy−1-hydroxyoctadecanoic acid.

Further, the epoxidized ester of the unsaturated long-chain fatty acid is an alkyl ester of epoxidized unsaturated fatty acid, such as 9, 10-epoxystearic acid methyl or ethyl or butyl or decyl ester, 9,10,12,13-epoxystearic acid propyl, and 2-ethylhexyl ester.

Take a molecular structure of epoxy grease as example, which is shown as follow:

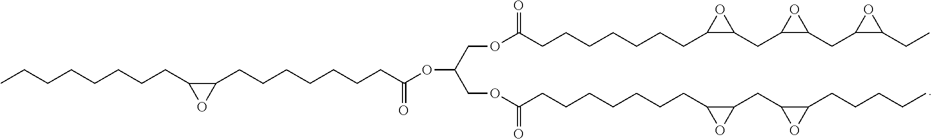 [SMILES: CCCCCCCCC1OC1CCCCCCCC(=O)OC(COC(=O)CCCCCCCC1OC1CC1OC1CCCCC)COC(=O)CCCCCCCC1OC1CC1OC1CC1OC1CC]

Further, a hydroxyl value of the bio-base polyol is in a range of 120 to 350 mgKOH/g, and a bio-based content is in a range of 90% to 100%.

Secondly, the present invention provides a polyurethane controlled release fertilizer which comprises fertilizer granules and a polyurethane controlled release fertilizer coating wrapped on a surface of each of the fertilizer granules, wherein the polyurethane controlled release fertilizer coating is prepared by curing the fully bio-based coating material for the polyurethane controlled release fertilizer on the surface of the each of the fertilizer granules.

Specifically, the fertilizer granules are conventional fertilizer granules, such as urea granules, diammonium phosphate granules, ammonium dihydrogen phosphate granules, calcium superphosphate granules, triple superphosphate granules, potassium chloride granules, potassium nitrate granules, and potassium sulfate granules.

The present invention has beneficial effects as follows.

(1) The curing agent isocyanate of the coating material for the polyurethane controlled release fertilizer is a bio-based PDI compound. Different from the traditional petroleum-based isocyanate (MDI), the curing agent isocyanate provided by the present invention is derived from bio-based materials such as glucose and lysine, and the proportion of bio-based materials is in a range of 65-71% by weight, so that the bio-based content is high. Therefore, the coating material for the polyurethane controlled release fertilizer is bio-based product which has better biocompatibility, higher biodegradability, and good environmental protection and safety performance.

(2) The bio-based polyol for preparing the coating material is prepared by performing the first esterification reaction, the ring-opening reaction and the second esterification reaction on the bio-based materials such as the epoxidized fatty acid ester, the lactic acid, the glycerol, the 1,3-propanediol, the 1,4-butanediol and the glycol. After the ring-opening reaction, the softness of the epoxidized fatty acid ester is combined with the rigidity of the lactic acid, so as to provide excellent mechanical properties for the polyurethane resin film (i.e., the controlled release fertilizer coating provided by the present invention), which greatly improves the abrasive resistance and the compressive property, and also improves the antibacterial and mildew resistance of the polyurethane resin film. Moreover, the mass percentage of bio-based materials in the bio-based polyol is in a range of 90% to 99%, the bio-based content is high.

(3) In the present invention, the bio-based polyol is quickly cross-linked with the bio-based PDI compound to prepare the coating material for the polyurethane controlled release fertilizer, the coating material is directly wrapped on the surface of each of the fertilizer granules to prepare the polyurethane controlled release fertilizer, wherein a mass percentage of bio-based materials accounts for 58.5%-70.29% of all raw materials.

(4) All raw materials of the fully bio-based coating material for the polyurethane controlled release fertilizer provided by the present invention are bio-based products which are easily available. Compared with the coating material produced by the traditional petroleum-based MDI or castor oil, the coating material provided by the present invention has high bio-based content, excellent controlled release performance, low brittleness at low temperature, strong wear resistance, and stable product structure and performance. Moreover, it is safe and environmental protection after being applied in soil, and has good degradation performance and very small environmental pollution.

### BRIEF DESCRIPTION OF THE DRAWINGS

FIG. 1 shows nitrogen cumulative release characteristics of coated urea with different coating rates of still water test according to the first embodiment of the present invention.

FIG. 2 shows nitrogen cumulative release characteristics of coated urea with different coating rates of still water test according to the second embodiment of the present invention.

FIG. 3 shows nitrogen cumulative release characteristics of coated urea with different coating rates of still water test according to the third embodiment of the present invention.

FIG. 4 shows nitrogen cumulative release characteristics of coated urea with different coating rates of still water test according to the fourth embodiment of the present invention.

FIG. 5 shows nitrogen cumulative release characteristics of coated urea with different coating rates of still water test according to the fifth embodiment of the present invention.

FIG. 6 shows nitrogen cumulative release characteristics of coated urea with different coating rates of still water test according to the sixth embodiment of the present invention.

FIG. 7 shows nitrogen cumulative release characteristics of coated urea with different coating rates of still water test according to the first control group of the present invention.

FIG. 8 shows nitrogen cumulative release characteristics of coated urea with different coating rates of still water test according to the second control group of the present invention.

### DETAILED DESCRIPTION OF THE PREFERRED EMBODIMENT

The present invention will be further described in combination with embodiments as follows. It is understood that the embodiments described herein are only used to clarify the technical scheme of the present invention more clearly, and are not intended to limit the protection scope of the present invention.

According to the embodiment of the present invention, a fully bio-based coating material for polyurethane controlled release fertilizer includes bio-based polyol, bio-based 1,5-pentane diisocyanate and polymers thereof, and fertilizer granules.

(1) Preparation and Raw Materials of Bio-Based Polyol

The bio-based polyol provided by the present invention is formed by ring-opening polymerization of epoxidized fatty acid ester, bio-based acid and bio-based alcohol. Specifically, the epoxidized fatty acid ester is an epoxide or an ester of a long-chain unsaturated fatty acid with an aliphatic chain of 10 to 24 carbon atoms and at least one ethylene oxide group, which is at least one member selected from a group consisting of epoxy soybean oil, epoxy corn oil, epoxy castor oil, epoxy cottonseed oil, epoxy hemp seed oil, epoxy tall oil, epoxy safflower seed oil, epoxy peanut oil, epoxy flaxseed oil, and epoxy rapeseed oil.

Also, the epoxidized fatty acid ester may be an epoxide of a long-chain unsaturated fatty oil with an esterified fatty acid chain of 10 to 24 carbon atoms, and the esterified fatty acid chain comprises at least one ethylene oxide group. Further, the epoxidized fatty acid ester is an epoxidized fatty oil, an epoxidized unsaturated fatty acid or an epoxidized ester of an unsaturated long-chain fatty acid. Specifically, the epoxidized unsaturated fatty acid is at least one member selected from a group consisting of 5,6-epoxy decanoic acid, 9,10-epoxy ricinoleic acid, 9,10-epoxy stearic acid, 4,5-epoxy decanoic acid, 9,10-epoxy octadecanoic acid, 9,10-epoxy tetracarboxylic acid, 8,9-epoxy-1-hydroxydecanoic acid, and 9, 10-epoxy-1-hydroxyoctadecanoic acid. The epoxidized ester of the unsaturated long-chain fatty acid is an alkyl ester of epoxidized unsaturated fatty acid, such as 9, 10-epoxystearic acid methyl or ethyl or butyl or decyl ester, 9,10,12,13-epoxystearic acid propyl, and 2-ethylhexyl ester. In the following embodiments, the epoxy soybean oil is taken as an example.

The bio-based acid is lactic acid. The bio-based alcohol is at least one member selected from a group consisting of glycerol, 1,3-propanediol, 1,4-butanediol, and glycol, wherein the glycerol is prepared by distillation from the by-product of biodiesel production; the glycol is prepared by preparing an ethylene oxide with bio-based ethanol, performing a ring-opening reaction on the ethylene oxide and water, and then distilling; the 1,3-propanediol is Zemea and Susterra provided by Huafon Company, China (former DuPont US) and the 1,4-butanediol is provided by Shandong Landian Biotechnology Co., Ltd. and Yuanli Chemical Science Group Co., Ltd., China.

In the present invention, the bio-based acid and the bio-based alcohol are bio-based products. The above raw materials are available on the market.

(2) Preparation and Selection of Bio-Based 1,5-Pentane Diisocyanate and Polymers Thereof

The bio-based 1,5-pentane diisocyanate (PDI) monomer provided by the present invention is prepared by fermenting glucose and lysine with bio-enzyme to obtain 1,5-pentanediamine, and performing a phosgenation reaction on 1,5-pentanediamine to obtain the PDI monomer. Further, PDI trimers, PDI tetramers and other multimers are prepared by the PDI monomer with catalysts.

Stabio™ PDI and Stabio™ D-370N, D-376N, D-3725N and other series products provided by Mitsui Chemicals are used in the following embodiments, in which Stabio™ PDI is a bio-based PDI monomer, Stabio™ D-370N and D-376N are bio-based PDI trimers, and Stabio™ D-3725N is a bio-based PDI tetramer.

(3) Fertilizer Granules

The fully bio-based coating material for the polyurethane controlled release fertilizer provided by the present invention is suitable for urea, diammonium phosphate, monoammonium phosphate, calcium superphosphate, calcium superphosphate, potassium chloride, potassium nitrate, potassium sulfate and other conventional fertilizer granules.

In the following embodiments, large granular urea is taken as an example.

### First Embodiment

(I) Preparation of bio-based polyol, which comprises steps of:
(1) preparing a lactate polyol intermediate product by performing an esterification reaction which comprises adding 16 mol of lactic acid, 1.2 mol of glycol, 0.3 mol of glycerol, 0.5 mol of 1,3-propanediol and zinc acetate which acts as an esterification catalyst into a reaction kettle, and heating up the reaction kettle to 100° C., wherein when an acid value drops below 20 mgKOH/g, the lactate polyol intermediate product is obtained; a mass percentage of the zinc acetate accounts for 5‰ of a first total reactant which consists of the lactic acid, the glycol, the glycerol, the 1,3-propanediol and the zinc acetate; and
(2) performing a ring-opening reaction which comprises adding epoxy soybean oil with an epoxy value of 6.1% into the lactate polyol intermediate product at 100-120° C. in batches, wherein a mass percentage of the epoxy soybean oil accounts for 18.02% of a second total reactant which consists of the epoxy soybean oil and the lactate polyol intermediate product; due to the ring-opening reaction is an exothermic reaction, a temperature of the reaction kettle is remained at 100° C. by controlling an adding speed of the epoxy soybean oil; a temperature of materials in the reaction kettle drops to 140° C. after completing addition of the epoxy soybean oil, and increasing the temperature to 160° C. to sufficiently perform the ring-opening reaction; maturing the ring-opening reaction by increasing the temperature to 160-180° C., remaining the temperature at 160-180° C. for half an hour, increasing the temperature to 260° C., detecting an acid value at 260° C.; when the acid value drops below 5 mgKOH/g, decreasing the temperature to 230° C., and performing rectification under vacuum with a vacuum degree in a range of −0.065 to −0.095 MPa till an acid value of a product after rectification drops below 2.0 mgKOH/g and a moisture mass percentage is less than 0.1%.

According to GB/T12008.3-2009 standard, an oxhydryl value of the obtained bio-based polyol tested by phthalic anhydride method is 124 mgKOH/g, in which a mass percentage of bio-based materials in all raw materials is about 95%.

(II) Preparation of a fully bio-based coating material for a polyurethane controlled release fertilizer and a polyurethane controlled release fertilizer, which comprises:

(1) preparing a bio-based PDI compound by mixing Stabio™ D-370N and Stabio™ D-376N of Mitsui products with a mass ratio of 90:10; and

(2) putting 50 kilograms of urea granules with a granular size in a range of 2.00 mm to 4.75 mm into a coating machine, heating up to 65° C.; weighing three 93 grams of the bio-based PDI compound and three 257 grams of the bio-based polyol mentioned above; by spraying onto surfaces of constantly moving urea granules in the coating machine after mixing one of the three 93 grams of the bio-based PDI compound with one of the three 257 grams of the bio-based polyol for three times, forming a film which is wrapped around each of the urea granules, wherein a coating ratio is 2.1% at this time, a molar ratio of an NCO group in the bio-based PDI compound to an oxhydryl group in the bio-based polyol is 1:1; solidifying for 3 to 5 minutes till a dense and tough polyurethane coating is formed on the each of the urea granules; adding paraffin for avoiding adhesion among the urea granules with the polyurethane coating, wherein a mass percentage of the paraffin accounts for 0.2% of the urea granules with the polyurethane coating, and cooling to 20° C., thereby obtaining the fully bio-based polyurethane coated urea which is recorded as S1 (Sample 1). Similarly, based on the table 1, a coating ratio of 2.7% is obtained through three 119 grams of the bio-based PDI compound and three 331 grams of the bio-based polyol; a coating ratio of 3.3% is obtained through three 145 grams of the bio-based PDI compound and three 405 grams of the bio-based polyol.

TABLE 1
Bio-based PDI compound and bio-based polyol added
into urea granules with an unit of grams

| | Coating ratio (Mass percentage | | |
|---|---|---|---|
| | of coating material in urea granules | | |
| | with the polyurethane coating) | | |
| | 2.1% | 2.7% | 3.3% |
| Bio-based PDI compound/every time | 93 | 119 | 145 |
| Bio-based polyol/every time | 257 | 331 | 405 |

### Second Embodiment

(I) Preparation of bio-based polyol, which comprises steps of:

(1) preparing a lactate polyol intermediate product by performing an esterification reaction which comprises adding 14 mol of lactic acid, 1.2 mol of glycol, 0.2 mol of glycerol, 0.8 mol of 1,3-propanediol and stannous chloride which acts as an esterification catalyst into a reaction kettle, and heating up the reaction kettle to 190° C., wherein when an acid value drops below 20 mgKOH/g, the lactate polyol intermediate product is obtained; a mass percentage of the stannous chloride accounts for 2‰ of a first total reactant which consists of the lactic acid, the glycol, the glycerol, the 1,3-propanediol and the stannous chloride; and

(2) performing a ring-opening reaction which comprises adding epoxy soybean oil with an epoxy value of 6.1% into the lactate polyol intermediate product at 100-120° C. in batches, wherein a mass percentage of the epoxy soybean oil accounts for 18.49% of a second total reactant which consists of the epoxy soybean oil and the lactate polyol intermediate product; due to the ring-opening reaction is an exothermic reaction, a temperature of the reaction kettle is remained at 130° C. by controlling an adding speed of the epoxy soybean oil; a temperature of materials in the reaction kettle drops to 140° C. after completing addition of the epoxy soybean oil; maturing the ring-opening reaction by increasing the temperature to 170° C., remaining the temperature at 170° C. for half an hour, increasing the temperature to 240° C., detecting an acid value at 240° C.; when the acid value drops below 5 mgKOH/g, decreasing the temperature to 225° C., and performing rectification under vacuum with a vacuum degree in a range of −0.065 to −0.095 MPa till an acid value of a product after rectification drops below 2.0 mgKOH/g and a moisture mass percentage is less than 0.1%.

According to GB/T12008.3-2009 standard, an oxhydryl value of the obtained bio-based polyol tested by phthalic anhydride method is 158 mgKOH/g, in which a mass percentage of bio-based materials in all raw materials is about 99%.

(II) Preparation of a fully bio-based coating material for a polyurethane controlled release fertilizer and a polyurethane controlled release fertilizer, which comprises:
(1) preparing a bio-based PDI compound by mixing Stabio™ D-370N and Stabio™ D-376N of Mitsui products with a mass ratio of 80:20; and
(2) putting 50 kilograms of urea granules with a granular size in a range of 2.00 mm to 4.75 mm into a coating machine, heating up to 65° C.; weighing three 113 grams of the bio-based PDI compound and three 237 grams of the bio-based polyol mentioned above; by spraying onto surfaces of constantly moving urea granules in the coating machine after mixing one of the three 113 grams of the bio-based PDI compound with one of the three 237 grams of the bio-based polyol for three times, forming a film which is wrapped around each of the urea granules, wherein a coating ratio is 2.1% at this time, a molar ratio of an NCO group in the bio-based PDI compound to an oxhydryl group in the bio-based polyol is 1:1; solidifying for 3 to 5 minutes till a dense and tough polyurethane coating is formed on the each of the urea granules; adding paraffin for avoiding adhesion among the urea granules with the polyurethane coating, wherein a mass percentage of the paraffin accounts for 0.2% of the urea granules with the polyurethane coating, and cooling to 20° C., thereby obtaining the fully bio-based polyurethane coated urea which is recorded as S2 (Sample 2). Similarly, based on the table 2, a coating ratio of 2.7% is obtained through three 145 grams of the bio-based PDI compound and three 305 grams of the bio-based polyol; a coating ratio of 3.3% is obtained through three 177 grams of the bio-based PDI compound and three 373 grams of the bio-based polyol.

TABLE 2
Bio-based PDI compound and bio-based polyol added
into urea granules with an unit of grams

| | Coating ratio (Mass percentage | | |
|---|---|---|---|
| | of coating material in urea granules | | |
| | with the polyurethane coating) | | |
| | 2.1% | 2.7% | 3.3% |
| Bio-based PDI compound/every time | 113 | 145 | 177 |
| Bio-based polyol/every time | 237 | 305 | 373 |

### Third Embodiment

(I) Preparation of bio-based polyol, which comprises steps of:

(1) preparing a lactate polyol intermediate product by performing an esterification reaction which comprises adding 15.0 mol of lactic acid, 1.0 mol of glycol, 3.0 mol of glycerol, 0.5 mol of 1,3-propanediol, 0.5 mol of 1, 4-butanediol and tetrabutyl titanate which acts as an esterification catalyst into a reaction kettle, and heating up the reaction kettle to 170° C., wherein when an acid value drops below 20 mgKOH/g, the lactate polyol intermediate product is obtained; a mass percentage of the tetrabutyl titanate accounts for 8‰ of a first total reactant which consists of the lactic acid, the glycol, the glycerol, the 1,3-propanediol, the 1, 4-butanediol and the tetrabutyl titanate; and

(2) performing a ring-opening reaction which comprises adding epoxy soybean oil with an epoxy value of 6.1% into the lactate polyol intermediate product at 100-120° C. in batches, wherein a mass percentage of the epoxy soybean oil accounts for 17.20% of a second total reactant which consists of the epoxy soybean oil and the lactate polyol intermediate product; due to the ring-opening reaction is an exothermic reaction, a temperature of the reaction kettle is remained at 150° C. by controlling an adding speed of the epoxy soybean oil; a temperature of materials in the reaction kettle drops to 140° C. after completing addition of the epoxy soybean oil, and increasing the temperature to 180° C. to sufficiently perform the ring-opening reaction; maturing the ring-opening reaction by increasing the temperature to 160-180° C., remaining the temperature at 160-180° C. for half an hour, increasing the temperature to 220° C., detecting an acid value at 220° C.; when the acid value drops below 5 mgKOH/g, decreasing the temperature to 200° C., and performing rectification under vacuum with a vacuum degree of −0.075 MPa till an acid value of a product after rectification drops below 2.0 mgKOH/g and a moisture mass percentage is less than 0.1%.

According to GB/T12008.3-2009 standard, an oxhydryl value of the obtained bio-based polyol tested by phthalic anhydride method is 348 mgKOH/g, in which a mass percentage of bio-based materials in all raw materials is about 97.9%.

(II) Preparation of a fully bio-based coating material for a polyurethane controlled release fertilizer and a polyurethane controlled release fertilizer, which comprises:
(1) preparing a bio-based PDI compound by mixing Stabio™ D-370N and Stabio™ PDI of Mitsui products with a mass ratio of 85:15; and
(2) putting 50 kilograms of urea granules with a granular size in a range of 2.00 mm to 4.75 mm into a coating machine, heating up to 65° C.; weighing three 168 grams of the bio-based PDI compound and three 182 grams of the bio-based polyol mentioned above; by spraying onto surfaces of constantly moving urea granules in the coating machine after mixing one of the three 168 grams of the bio-based PDI compound with one of the three 182 grams of the bio-based polyol for three times, forming a film which is wrapped around each of the urea granules, wherein a coating ratio is 2.1% at this time, a molar ratio of an NCO group in the bio-based PDI compound to an oxhydryl group in the bio-based polyol is 1:1; solidifying for 3 to 5 minutes till a dense and tough polyurethane coating is formed on the each of the urea granules; adding paraffin for avoiding adhesion among the urea granules with the polyurethane coating, wherein a mass percentage of the paraffin accounts for 0.2% of the urea granules with the polyurethane coating, and cooling to 20° C., thereby obtaining the fully bio-based polyurethane coated urea which is recorded as S3 (Sample 3). Similarly, based on the table 3, a coating ratio of 2.7% is obtained through three 216 grams of the bio-based PDI compound and three 234 grams of the bio-based polyol; a coating ratio of 3.3% is obtained through three 264 grams of the bio-based PDI compound and three 286 grams of the bio-based polyol.

TABLE 3
Bio-based PDI compound and bio-based polyol added
into urea granules with an unit of grams

| | Coating ratio (Mass percentage | | |
|---|---|---|---|
| | of coating material in urea granules | | |
| | with the polyurethane coating) | | |
| | 2.1% | 2.7% | 3.3% |
| Bio-based PDI compound/every time | 168 | 216 | 264 |
| Bio-based polyol/every time | 182 | 234 | 286 |

### Fourth Embodiment

(I) Preparation of bio-based polyol, which comprises steps of:

(1) preparing a lactate polyol intermediate product by performing an esterification reaction which comprises adding 12.0 mol of lactic acid, 0.7 mol of glycol, 0.7 mol of glycerol, 0.5 mol of 1,3-propanediol, 0.1 mol of 1,4-butanediol and dibutyltin oxide which acts as an esterification catalyst into a reaction kettle, and heating up the reaction kettle to 185° C., wherein when an acid value drops below 20 mgKOH/g, the lactate polyol intermediate product is obtained; a mass percentage of the dibutyltin oxide accounts for 3‰ of a first total reactant which consists of the lactic acid, the glycol, the glycerol, the 1,3-propanediol, the 1,71-butanediol and the dibutyltin oxide and

(2) performing a ring-opening reaction which comprises adding epoxy soybean oil with an epoxy value of 6.1% into the lactate polyol intermediate product at 100-120° C. in batches, wherein a mass percentage of the epoxy soybean oil accounts for 17.29% of a second total reactant which consists of the epoxy soybean oil and the lactate polyol intermediate product; due to the ring-opening reaction is an exothermic reaction, a temperature of the reaction kettle is remained at 170° C. by controlling an adding speed of the epoxy soybean oil; a temperature of materials in the reaction kettle drops to 140° C. after completing addition of the epoxy soybean oil; maturing the ring-opening reaction by increasing the temperature to 170° C., remaining the temperature at 170° C. for half an hour, increasing the temperature to 235° C., detecting an acid value at 235° C.; when the acid value drops below 5 mgKOH/g, decreasing the temperature to 220° C., and performing rectification under vacuum with a vacuum degree of −0.083 MPa till an acid value of a product after rectification drops below 2.0 mgKOH/g and a moisture mass percentage is less than 0.1%.

According to GB/T12008.3-2009 standard, an oxhydryl value of the obtained bio-based polyol tested by phthalic anhydride method is 196 mgKOH/g, in which a mass percentage of bio-based materials in all raw materials is about 96.8%.

(II) Preparation of a fully bio-based coating material for a polyurethane controlled release fertilizer and a polyurethane controlled release fertilizer, which comprises:
(1) preparing a bio-based PDI compound by mixing Stabio™ D-370N and Stabio™ D-376N of Mitsui products with a mass ratio of 70:30; and
(2) putting 50 kilograms of urea granules with a granular size in a range of 2.00 mm to 4.75 mm into a coating machine, heating up to 65° C.; weighing three 131 grams of the bio-based PDI compound and three 219 grams of the bio-based polyol mentioned above; by spraying onto surfaces of constantly moving urea granules in the coating machine after mixing one of the three 131 grams of the bio-based PDI compound with one of the three 219 grams of the bio-based polyol for three times, forming a film which is wrapped around each of the urea granules, wherein a coating ratio is 2.1% at this time, a molar ratio of an NCO group in the bio-based PDI compound to an oxhydryl group in the bio-based polyol is 1:1; solidifying for 3 to 5 minutes till a dense and tough polyurethane coating is formed on the each of the urea granules; adding paraffin for avoiding adhesion among the urea granules with the polyurethane coating, wherein a mass percentage of the paraffin accounts for 0.2% of the urea granules with the polyurethane coating, and cooling to 20° C., thereby obtaining the fully bio-based polyurethane coated urea which is recorded as S4 (Sample 4). Similarly, based on the table 4, a coating ratio of 2.7% is obtained through three 169 grams of the bio-based PDI compound and three 281 grams of the bio-based polyol; a coating ratio of 3.3% is obtained through three 207 grams of the bio-based PDI compound and three 343 grams of the bio-based polyol.

TABLE 4
Bio-based PDI compound and bio-based polyol added
into urea granules with an unit of grams

| | Coating ratio (Mass percentage | | |
|---|---|---|---|
| | of coating material in urea granules | | |
| | with the polyurethane coating) | | |
| | 2.1% | 2.7% | 3.3% |
| Bio-based PDI compound/every time | 131 | 169 | 207 |
| Bio-based polyol/every time | 219 | 281 | 343 |

### Fifth Embodiment

(I) Preparation of bio-based polyol, which comprises steps of:

(1) preparing a lactate polyol intermediate product by performing an esterification reaction which comprises adding 13 mol of lactic acid, 1.0 mol of glycol, 2.0 mol of glycerol and dibutyltin dilaurate which acts as an esterification catalyst into a reaction kettle, and heating up the reaction kettle to 180° C., wherein when an acid value drops below 20 mgKOH/g, the lactate polyol intermediate product is obtained; a mass percentage of the dibutyltin dilaurate accounts for 5‰ of a first total reactant which consists of the lactic acid, the glycol, the glycerol, and the dibutyltin dilaurate; and

(2) performing a ring-opening reaction which comprises adding epoxy soybean oil with an epoxy value of 6.1% into the lactate polyol intermediate product at 100-120° C. in batches, wherein a mass percentage of the epoxy soybean oil accounts for 16.91% of a second total reactant which consists of the epoxy soybean oil and the lactate polyol intermediate product; due to the ring-opening reaction is an exothermic reaction, a temperature of the reaction kettle is remained at 150° C. by controlling an adding speed of the epoxy soybean oil; a temperature of materials in the reaction kettle drops to 140° C. after completing addition of the epoxy soybean oil; maturing the ring-opening reaction by increasing the temperature to 170° C., remaining the temperature at 170° C. for half an hour, increasing the temperature to 210° C., detecting an acid value at 210° C.; when the acid value drops below 5 mgKOH/g, decreasing the temperature to 200° C., and performing rectification under vacuum with a vacuum degree of −0.080 MPa till an acid value of a product after rectification drops below 2.0 mgKOH/g and a moisture mass percentage is less than 0.1%.

According to GB/T12008.3-2009 standard, an oxhydryl value of the obtained bio-based polyol tested by phthalic anhydride method is 293 mgKOH/g, in which a mass percentage of bio-based materials in all raw materials is about 97.0%.

(II) Preparation of a fully bio-based coating material for a polyurethane controlled release fertilizer and a polyurethane controlled release fertilizer, which comprises:
(1) preparing a bio-based PDI compound by mixing Stabio™ D-370N and Stabio™ PDI of Mitsui products with a mass ratio of 85:15; and
(2) putting 50 kilograms of urea granules with a granular size in a range of 2.00 mm to 4.75 mm into a coating machine, heating up to 65° C.; weighing three 151 grams of the bio-based PDI compound and three 199 grams of the bio-based polyol mentioned above; by spraying onto surfaces of constantly moving urea granules in the coating machine after mixing one of the three 151 grams of the bio-based PDI compound with one of the three 199 grams of the bio-based polyol for three times, forming a film which is wrapped around each of the urea granules, wherein a coating ratio is 2.1% at this time, a molar ratio of an NCO group in the bio-based PDI compound to an oxhydryl group in the bio-based polyol is 1:1; solidifying for 3 to 5 minutes till a dense and tough polyurethane coating is formed on the each of the urea granules; adding paraffin for avoiding adhesion among the urea granules with the polyurethane coating, wherein a mass percentage of the paraffin accounts for 0.2% of the urea granules with the polyurethane coating, and cooling to 20° C., thereby obtaining the fully bio-based polyurethane coated urea which is recorded as S5 (Sample 5). Similarly, based on the table 5, a coating ratio of 2.7% is obtained through three 194 grams of the bio-based PDI compound and three 256 grams of the bio-based polyol; a coating ratio of 3.3% is obtained through three 237 grams of the bio-based PDI compound and three 313 grams of the bio-based polyol.

TABLE 5
Bio-based PDI compound and bio-based polyol added
into urea granules with an unit of grams

| | Coating ratio (Mass percentage | | |
|---|---|---|---|
| | of coating material in urea granules | | |
| | with the polyurethane coating) | | |
| | 2.1% | 2.7% | 3.3% |
| Bio-based PDI compound/every time | 151 | 194 | 237 |
| Bio-based polyol/every time | 199 | 256 | 313 |

### Sixth Embodiment

(I) Preparation of bio-based polyol, which comprises steps of:

(1) preparing a lactate polyol intermediate product by performing an esterification reaction which comprises adding 18 mol of lactic acid, 1.0 mol of glycol, 3.0 mol of glycerol, 0.5 mol of 1,3-propanediol and zinc acetate which acts as an esterification catalyst into a reaction kettle, and heating up the reaction kettle to 175° C., wherein when an acid value drops below 20 mgKOH/g, the lactate polyol intermediate product is obtained; a mass percentage of the zinc acetate accounts for 4‰ of a first total reactant which consists of the lactic acid, the glycol, the glycerol, the 1,3-propanediol and the zinc acetate; and

(2) performing a ring-opening reaction which comprises adding epoxy soybean oil with an epoxy value of 6.1% into the lactate polyol intermediate product at 155° C. in batches, wherein a mass percentage of the epoxy soybean oil accounts for 15.57% of a second total reactant which consists of the epoxy soybean oil and the lactate polyol intermediate product; due to the ring-opening reaction is an exothermic reaction, a temperature of the reaction kettle is remained at 160° C. by controlling an adding speed of the epoxy soybean oil; a temperature of materials in the reaction kettle drops to 140° C. after completing addition of the epoxy soybean oil; maturing the ring-opening reaction by increasing the temperature to 180° C., remaining the temperature at 180° C. for half an hour, increasing the temperature to 230° C., detecting an acid value at 230° C.; when the acid value drops below 5 mgKOH/g, decreasing the temperature to 210° C., and performing rectification under vacuum with a vacuum degree of −0.075 MPa till an acid value of a product after rectification drops below 2.0 mgKOH/g and a moisture mass percentage is less than 0.1%.

According to GB/T12008.3-2009 standard, an oxhydryl value of the obtained bio-based polyol tested by phthalic anhydride method is 317 mgKOH/g, in which a mass percentage of bio-based materials in all raw materials is about 98.1%.

(II) Preparation of a fully bio-based coating material for a polyurethane controlled release fertilizer and a polyurethane controlled release fertilizer, which comprises:
(1) preparing a bio-based PDI compound by mixing Stabio™ D-370N and Stabio™ PDI of Mitsui products with a mass ratio of 85:15; and
(2) putting 50 kilograms of urea granules with a granular size in a range of 2.00 mm to 4.75 mm into a coating machine, heating up to 65° C.; weighing three 157 grams of the bio-based PDI compound and three 193 grams of the bio-based polyol mentioned above; by spraying onto surfaces of constantly moving urea granules in the coating machine after mixing one of the three 157 grams of the bio-based PDI compound with one of the three 193 grams of the bio-based polyol for three times, forming a film which is wrapped around each of the urea granules, wherein a coating ratio is 2.1% at this time, a molar ratio of an NCO group in the bio-based PDI compound to an oxhydryl group in the bio-based polyol is 1:1; solidifying for 3 to 5 minutes till a dense and tough polyurethane coating is formed on the each of the urea granules; adding paraffin for avoiding adhesion among the urea granules with the polyurethane coating, wherein a mass percentage of the paraffin accounts for 0.2% of the urea granules with the polyurethane coating, and cooling to 20° C., thereby obtaining the fully bio-based polyurethane coated urea which is recorded as S6 (Sample 6). Similarly, based on the table 6, a coating ratio of 2.7% is obtained through three 202 grams of the bio-based PDI compound and three 248 grams of the bio-based polyol; a coating ratio of 3.3% is obtained through three 247 grams of the bio-based PDI compound and three 303 grams of the bio-based polyol.

TABLE 6
Bio-based PDI compound and bio-based polyol added
into urea granules with an unit of grams

| | Coating ratio (Mass percentage | | |
|---|---|---|---|
| | of coating material in urea granules | | |
| | with the polyurethane coating) | | |
| | 2.1% | 2.7% | 3.3% |
| Bio-based PDI compound/every time | 157 | 202 | 247 |
| Bio-based polyol/every time | 193 | 248 | 303 |

First Control Group: The bio-based polyol provided by the present invention is replaced by the bio-based polyol without introducing lactic acid

(I) Preparation of bio-based polyol, which comprises steps of:

preparing an alcohol mixture by adding 1 mol of glycol, 2 mol of 1,3-propanediol and zinc acetate into a reaction kettle, heating up the reaction kettle to 155° C., performing a ring-opening reaction by adding 0.5 mol of epoxy soybean oil with an epoxy value of 6.1% into the alcohol mixture, remaining a temperature of the reaction kettle in a range of 155 to 160° C., decreasing a temperature of materials in the reaction kettle to 140° C. after completing addition of the epoxy soybean oil, maturing the ring-opening reaction by increasing the temperature of the materials in the reaction kettle to 180° C., remaining the temperature at 180° C. for half an hour, decreasing the temperature to 160° C., increasing the temperature to 230° C., detecting an acid value at 230° C.; when the acid value drops below 5 mgKOH/g, decreasing the temperature to 210° C.; and performing rectification under vacuum to remove excess alcohol with a vacuum degree below −0.090 MPa till a temperature of a tower top decreases to 40° C., an acid value of a product after rectification drops below 2.0 mgKOH/g and a moisture mass percentage is less than 0.1%.

According to GB/T12008.3-2009 standard, an oxhydryl value of the obtained bio-based polyol tested by phthalic anhydride method is 162 mgKOH/g, in which a mass percentage of bio-based materials in all raw materials is about 98.1%.

(II) Preparation of a fully bio-based coating material for a polyurethane controlled release fertilizer and a polyurethane controlled release fertilizer, which comprises:
(1) preparing a bio-based PDI compound by mixing Stabio™ D-370N and Stabio™ D-376N of Mitsui products with a mass ratio of 70:30; and
(2) putting 50 kilograms of urea granules with a granular size in a range of 2.00 mm to 4.75 mm into a coating machine, heating up to 65° C.; weighing three 115 grams of the bio-based PDI compound and three 235 grams of the bio-based polyol mentioned above; by spraying onto surfaces of constantly moving urea granules in the coating machine after mixing one of the three 115 grams of the bio-based PDI compound with one of the three 235 grams of the bio-based polyol for three times, forming a film which is wrapped around each of the urea granules, wherein a coating ratio is 2.1% at this time, a molar ratio of an NCO group in the bio-based PDI compound to an oxhydryl group in the bio-based polyol is 1:1; solidifying for 3 to 5 minutes till a dense and tough polyurethane coating is formed on the each of the urea granules; adding paraffin for avoiding adhesion among the urea granules with the polyurethane coating, wherein a mass percentage of the paraffin accounts for 0.2% of the urea granules with the polyurethane coating, and cooling to 20° C., thereby obtaining the fully bio-based polyurethane coated urea which is recorded as S7 (Sample 7). Similarly, based on the table 7, a coating ratio of 2.7% is obtained through three 148 grams of the bio-based PDI compound and three 302 grams of the bio-based polyol; a coating ratio of 3.3% is obtained through three 181 grams of the bio-based PDI compound and three 369 grams of the bio-based polyol.

TABLE 7
Bio-based PDI compound and bio-based polyol added
into urea granules with an unit of grams

| | Coating ratio (Mass percentage | | |
|---|---|---|---|
| | of coating material in urea granules | | |
| | with the polyurethane coating) | | |
| | 2.1% | 2.7% | 3.3% |
| Bio-based PDI compound/every time | 115 | 148 | 181 |
| Bio-based polyol/every time | 235 | 302 | 369 |

Second Control Group: The bio-based PDI compound provided by the present invention is replaced by polymeric MDI (methylene diphenyl diisocyanate)

Put 50 kilograms of urea granules with a granular size in a range of 2.00 mm to 4.75 mm into a coating machine, heat up to 65° C.; weigh three 113 grams of the polymeric MDI (PM-200 with an NCO content of 31% produced by Wanhua Chemical Group Co., Ltd., China) and three 342 grams of the bio-based polyol mentioned above; by spraying onto surfaces of constantly moving urea granules in the coating machine after mixing one of the three 113 grams of the polymeric MDI with one of the three 342 grams of the bio-based polyol for three times, form a film which is wrapped around each of the urea granules, wherein a coating ratio is 2.1% at this time, a molar ratio of an NCO group in the polymeric MDI to an oxhydryl group in the bio-based polyol is 1:1; solidify for 3 to 5 minutes till a dense and tough polyurethane coating is formed on the each of the urea granules; add paraffin for avoiding adhesion among the urea granules with the polyurethane coating, wherein a mass percentage of the paraffin accounts for 0.2% of the urea granules with the polyurethane coating, and cool to 20° C., thereby obtaining the fully bio-based polyurethane coated urea which is recorded as S8 (Sample 8). Similarly, based on the table 8, a coating ratio of 2.7% is obtained through three 145 grams of the polymeric MDI and three 305 grams of the bio-based polyol; a coating ratio of 3.3% is obtained through three 177 grams of the polymeric MDI and three 373 grams of the bio-based polyol.

TABLE 8
Polymeric MDI and bio-based polyol added
into urea granules with an unit of grams

| | Coating ratio (Mass percentage | | |
|---|---|---|---|
| | of coating material in urea granules | | |
| | with the polyurethane coating) | | |
| | 2.1% | 2.7% | 3.3% |
| Polymeric MDI (PM-200)/every time | 113 | 145 | 177 |
| Bio-based polyol (Fourth | 342 | 305 | 373 |
| Embodiment)/every time | | | |

The properties of polyurethane controlled release urea fertilizers prepared according to the first to sixth embodiments, and the first and second control groups are tested as follows.

(1) Test of Controlled Release Performance

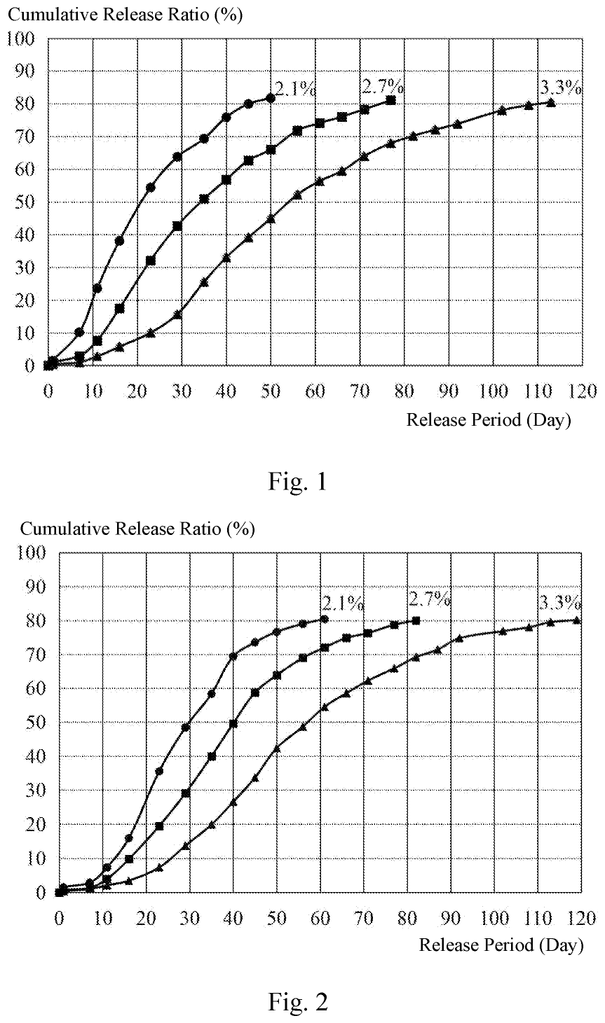

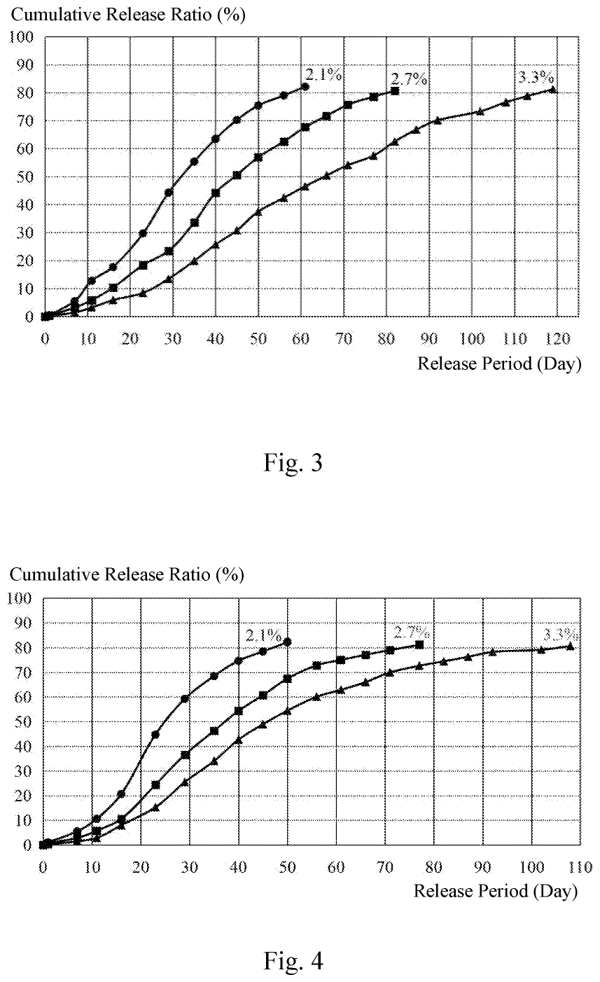

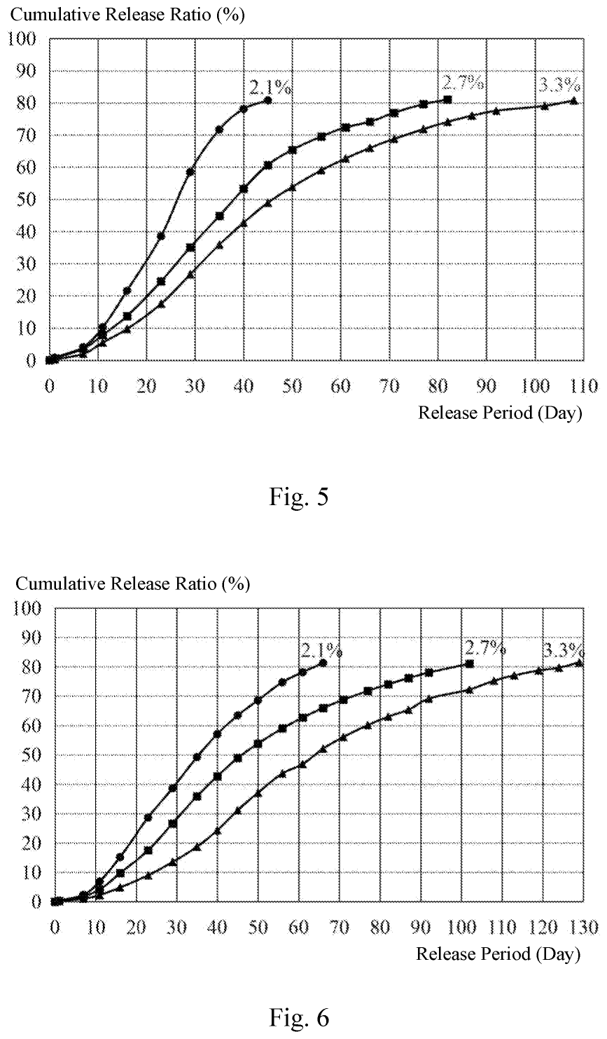

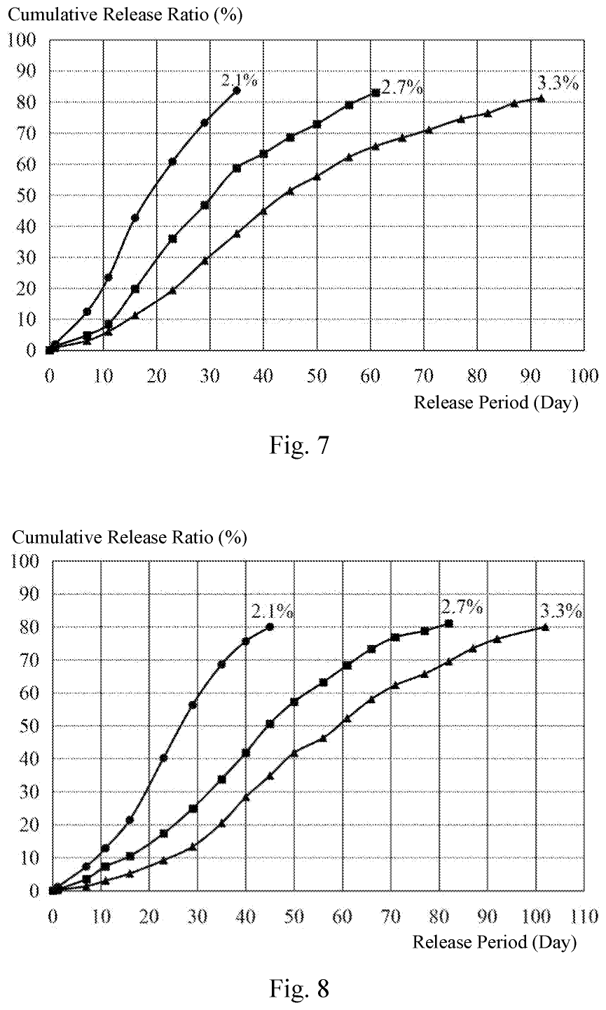

The nutrient release period of the controlled release fertilizer at 25° C. is tested by hydrostatic extraction method, which is expressed by the number of days required when the cumulative nutrient release rate reaches 80%. The nitrogen cumulative release rate in still water is measured by sampling in different days. Finally, the nitrogen cumulative release rates of the controlled release urea fertilizers prepared according to the above first to sixth embodiments and the first and second control groups, which are tested by hydrostatic extraction method, are recorded. These data are shown in FIGS. 1-7.

The results show that at the same coating rate, the controlled release fertilizers prepared according to the first to sixth embodiments provided by the present invention have a longer nitrogen cumulative release period than those prepared according to the first and second control groups. According to the present invention, when the polymeric MDI is replaced by bio-based PDI compound, the nitrogen cumulative release period is not much different. Therefore, due to the same controlled release performance, the polymeric MDI is able to be replaced by the bio-based PDI compound. It is able to be known that the introduction of lactic acid in bio-based polyol significantly increases the release period of the film.

(2) Initial Release Rate and Release Period

The nutrient release periods of the coated polyurethane controlled release urea fertilizers prepared according to the first to sixth embodiment, and the first and second control groups S1-S8, are tested by hydrostatic extraction method, which are expressed by the number of days required when the cumulative nutrient release rate reaches 80%. Moreover, the release rate of the first day tested by hydrostatic extraction method is regarded as the initial release rate. The nitrogen release periods and the initial release rates of the coated polyurethane controlled release urea fertilizers prepared according to the above first to sixth embodiments and the first and second control groups, which are tested by hydrostatic extraction method, are shown in Table 9.

TABLE 9
Nitrogen release periods and initial release rates of the coated
polyurethane controlled release urea fertilizers prepared according
to the first to sixth embodiments and the first and second control
groups which are tested by hydrostatic extraction method

| Experimental Group | Initial Release Rate (%) | | | Release Period (days) | | |
|---|---|---|---|---|---|---|
| (Coating Ratio) | 2.1% | 2.7% | 3.3% | 2.1% | 2.7% | 3.3% |
| First Embodiment | 1.55 | 0.78 | 0.35 | 45 | 75 | 112 |
| Second Embodiment | 1.48 | 0.98 | 0.35 | 60 | 82 | 118 |
| Third Embodiment | 0.48 | 0.30 | 0.18 | 58 | 81 | 116 |
| Fourth Embodiment | 1.03 | 0.67 | 0.25 | 47 | 78 | 105 |
| Fifth Embodiment | 0.78 | 0.62 | 0.25 | 42 | 78 | 105 |
| Sixth Embodiment | 0.35 | 0.23 | 0.2 | 64 | 98 | 125 |
| First Control Group | 1.89 | 1.23 | 0.76 | 32 | 57 | 89 |
| Second Control Group | 1.13 | 0.34 | 0.22 | 45 | 80 | 102 |

The results show that, in general, under the same coating ratio, the fertilizers prepared according to the first to sixth embodiments provided by the present invention have a longer release period than the fertilizers prepared according to the first and second control groups; and especially, compared with the first control group, the introduction of lactic acid in bio-based polyol prepared according to the first to sixth embodiments results in a larger increase in release period. However, due to the larger molecular weight of polyol in the first control group, the experiment found that the larger the molecular weight, the higher the initial release rate. Therefore, the present invention provides a coating material which is prepared by cross-linking the bio-based PDI compound and the bio-based polyol with lactic acid, such that the release time of the prepared coating material is extended to a certain extent, which is able to reduce the use of the coating material.

(3) Test of Water Balloon Rupture Rate

The coated polyurethane controlled release urea fertilizers S1 to S8 are prepared according to the first to sixth embodiments and the first and second control groups respectively. A free fall experiment is performed on water balloons, wherein more than 80% of nitrogen of the fertilizers is released at 25° C., which is tested by hydrostatic extraction method. The test method comprises steps of selecting fifty full water balloons with a size in a range of 4 to 4.5 mm, performing a free fall motion from a 1-meter-high experimental platform after drying water on surfaces of the balloons with absorbent paper, so as to test the water balloon rupture rate. Experimental data are shown in Table 10.

TABLE 10
Water balloon rupture rate of the coated polyurethane
controlled release urea fertilizers prepared according
to the first to sixth embodiments and the first and
second control groups after hydrostatic immersion

| Experimental Group | Water Balloon Rupture Rate (%) | | |
|---|---|---|---|
| (Coating Ratio) | 2.1% | 2.7% | 3.3% |
| First Embodiment | 27 | 18 | 8 |
| Second Embodiment | 23 | 17 | 6 |
| Third Embodiment | 24 | 13 | 7 |
| Fourth Embodiment | 17 | 10 | 5 |
| Fifth Embodiment | 10 | 7 | 3 |
| Sixth Embodiment | 20 | 14 | 5 |
| First Control Group | 48 | 30 | 12 |
| Second Control Group | 36 | 20 | 12 |

The results show that under the same coating ratio, the fertilizers prepared according to the first to sixth embodiments have a lower water balloon rupture rate than the fertilizers prepared according to the first and second control groups, indicating that the compressive performance is significantly improved. This is because the introduction of lactic acid in bio-based polyol improves the mechanical strength of the coating material, enhances the ability of coated urea fertilizers to resist damage in the process of releasing nutrients in the field, and prevents the effect of controlled release fertilizers from being affected by the rupture of the coating material.

(4) Test of Water Balloon Rupture Rate

The coated polyurethane controlled release urea fertilizers S1 to S8 are prepared according to the first to sixth embodiments and the first and second control groups respectively. At normal temperature, 100 g of the coated polyurethane controlled release urea fertilizers are added into the coating machine with a diameter of 500 mm, perform the high-speed movement at a rotational speed of 60 rpm for 1 hour, and then are boiled in boiling water for 10 minutes. At this time, the change of the number of broken water balloons of the product, and relevant data are shown in Table 11.

TABLE 11
The number of broken water balloons of the coated polyurethane
controlled release urea fertilizers prepared according
to the first to sixth embodiments and the first and second
control groups at high-speed movement

| | The original number | | | The number of broken | | |
|---|---|---|---|---|---|---|
| | of broken water | | | water balloons of | | |
| Experimental Group | balloons of Samples | | | Samples after experiments | | |
| (Coating Ratio) | 2.1% | 2.7% | 3.3% | 2.1% | 2.7% | 3.3% |
| First Embodiment | 8 | 4 | 0 | 18 | 10 | 2 |
| Second Embodiment | 8 | 2 | 0 | 15 | 8 | 3 |
| Third Embodiment | 4 | 0 | 0 | 20 | 14 | 5 |
| Fourth Embodiment | 3 | 1 | 0 | 13 | 7 | 3 |
| Fifth Embodiment | 2 | 0 | 0 | 8 | 5 | 2 |
| Sixth Embodiment | 3 | 0 | 0 | 9 | 4 | 3 |
| First Control Group | 30 | 15 | 3 | 61 | 34 | 15 |
| Second Control Group | 5 | 4 | 0 | 41 | 26 | 7 |

The results show that under the same coating ratio, the fertilizers prepared according to the first to sixth embodiments have a lower number of broken water balloons than the fertilizers prepared according to the first and second control groups, indicating that the abrasion resistance is significantly improved. Through above data, it is able to be known that the abrasion resistance of the coating material, which is prepared by cross-linking the bio-based PDI compound and the bio-based polyol with lactic acid, is greatly enhanced, and especially the strength of the coating material is improved by the introduction of lactic acid, and the mechanical performance thereof is increased. In addition, after the polymeric MDI is replaced by the bio-based PDI compound, the abrasion resistance of the coating material is also improved.

The above are only preferred embodiments of the present invention and are not intended to limit the present invention. Although the present invention is described in detail by reference to the above-mentioned embodiments, it is still possible for those skilled in the art to modify the technical scheme described in the above-mentioned embodiments or to make equivalent substitutions for some of the technical features. Any modification, equivalent replacement, improvement, etc. made within the spirit and principles of the present invention shall be included in the protection scope of the present invention.

What is claimed is:

1. A fully bio-based coating material for a polyurethane controlled release fertilizer, wherein:
a curing agent isocyanate of the coating material is a bio-based 1,5-pentane diisocyanate compound;
the bio-based 1,5-pentane diisocyanate compound is a compound of a bio-based 1,5-pentane diisocyanate monomer and its polymer, or a compound of different bio-based 1,5-pentane diisocyanate polymers.

2. The coating material according to claim 1, wherein an average functionality of the bio-based 1,5-pentane diisocyanate compound is in a range of 2.8 to 3.5, a content of NCO thereof is in a range of 24% to 30%, and a mass percentage of bio-based materials accounts for 65% to 71% of all raw materials.

3. The coating material according to claim 1, wherein the bio-based PDI (1,5-pentane diisocyanate) polymer comprises a bio-based PDI trimer and its derivatives, a bio-based PDI tetramer and its derivatives, and other bio-based PDI multimers and their derivatives, wherein:
the bio-based PDI monomer is prepared by a method which comprises steps of preparing 1,5-pentanediamine by fermenting a bio-based material with a bio-enzyme, and performing a phosgenation reaction on the 1,5-pentanediamine;
the bio-based material is at least one member selected from a group consisting of glucose and lysine;
the bio-based PDI trimer and its derivatives, the bio-based PDI tetramer and its derivatives, and other bio-based PDI multimers and their derivatives are prepared by performing a polymerization reaction on the bio-based PDI monomer with a catalyst.

4. The coating material according to claim 2, wherein the bio-based PDI (1,5-pentane diisocyanate) polymer comprises a bio-based PDI trimer and its derivatives, a bio-based PDI tetramer and its derivatives, and other bio-based PDI multimers and their derivatives, wherein:
the bio-based PDI monomer is prepared by a method which comprises steps of preparing 1,5-pentanediamine by fermenting a bio-based material with a bio-enzyme, and performing a phosgenation reaction on the 1,5-pentanediamine;
the bio-based material is at least one member selected from a group consisting of glucose and lysine;
the bio-based PDI trimer and its derivatives, the bio-based PDI tetramer and its derivatives, and other bio-based PDI multimers and their derivatives are prepared by performing a polymerization reaction on the bio-based PDI monomer with a catalyst.

5. The coating material according to claim 1, wherein:
the coating material is prepared by cross-linking the bio-based polyol and the bio-based 1,5-pentane diisocyanate compound;
a molar ratio of an oxhydryl group in the bio-based polyol to the NCO group in the bio-based PDI compound is in a range of (0.98-1.10):1.

6. The coating material according to claim 2, wherein:
the coating material is prepared by cross-linking the bio-based polyol and the bio-based 1,5-pentane diisocyanate compound;
a molar ratio of an oxhydryl group in the bio-based polyol to the NCO group in the bio-based PDI compound is in a range of (0.98-1.10):1.

7. The coating material according to claim 5, wherein:
the bio-based polyol is prepared by performing a ring-opening polymerization reaction on epoxidized fatty acid ester, bio-based acid and bio-based alcohol;
the bio-based acid is lactic acid, and the bio-based alcohol is at least one member selected from a group consisting of glycerol, 1,3-propanediol, 1,4-butanediol, and glycol;
the bio-based polyol is prepared by a method which comprises steps of:
(1) preparing a lactate polyol intermediate product by performing an esterification reaction on the lactic acid, the bio-based alcohol and an esterification catalyst, wherein a molar ratio of the oxhydryl group in the lactic acid to that in the bio-based alcohol is in a range of 4:1 to 8:1; and
(2) performing a ring-opening reaction by adding the epoxidized fatty acid ester into the lactate polyol intermediate product in batches for obtaining the bio-based polyol, wherein a mass percentage of the epoxidized fatty acid ester accounts for 15%-20% of a total reactant which consists of the epoxidized fatty acid ester and the lactate polyol intermediate product.

8. The coating material according to claim 6, wherein:
the bio-based polyol is prepared by performing a ring-opening polymerization reaction on epoxidized fatty acid ester, bio-based acid and bio-based alcohol;
the bio-based acid is lactic acid, and the bio-based alcohol is at least one member selected from a group consisting of glycerol, 1,3-propanediol, 1,4-butanediol, and glycol;
the bio-based polyol is prepared by a method which comprises steps of:
(1) preparing a lactate polyol intermediate product by performing an esterification reaction on the lactic acid, the bio-based alcohol and an esterification catalyst, wherein a molar ratio of the oxhydryl group in the lactic acid to that in the bio-based alcohol is in a range of 4:1 to 8:1; and
(2) performing a ring-opening reaction by adding the epoxidized fatty acid ester into the lactate polyol intermediate product in batches for obtaining the bio-based polyol, wherein a mass percentage of the epoxidized fatty acid ester accounts for 15%-20% of a total reactant which consists of the epoxidized fatty acid ester and the lactate polyol intermediate product.

9. The coating material according to claim 7, wherein:
the epoxidized fatty acid ester is an epoxide or an ester of a long-chain unsaturated fatty acid with an aliphatic chain of 10 to 24 carbon atoms and at least one ethylene oxide group;
or an epoxide of a long-chain unsaturated fatty oil with an esterified fatty acid chain of 10 to 24 carbon atoms, and the esterified fatty acid chain comprises at least one ethylene oxide group.

10. The coating material according to claim 8, wherein:
the epoxidized fatty acid ester is an epoxide or an ester of a long-chain unsaturated fatty acid with an aliphatic chain of 10 to 24 carbon atoms and at least one ethylene oxide group;
or an epoxide of a long-chain unsaturated fatty oil with an esterified fatty acid chain of 10 to 24 carbon atoms, and the esterified fatty acid chain comprises at least one ethylene oxide group.

11. The coating material according to claim 9, wherein:
the epoxidized fatty acid ester is an epoxidized fatty oil, an epoxidized unsaturated fatty acid or an epoxidized ester of an unsaturated long-chain fatty acid;
the epoxidized fatty oil is at least one member selected from a group consisting of epoxy soybean oil, epoxy corn oil, epoxy castor oil, epoxy cottonseed oil, epoxy hemp seed oil, epoxy tall oil, epoxy safflower seed oil, epoxy peanut oil, epoxy flaxseed oil, and epoxy rapeseed oil;
the epoxidized unsaturated fatty acid is at least one member selected from a group consisting of 5,6-epoxy decanoic acid, 9,10-epoxy ricinoleic acid, 9,10-epoxy stearic acid, 4,5-epoxy decanoic acid, 9,10-epoxy octadecanoic acid, 9,10-epoxy tetracarboxylic acid, 8,9-epoxy-1-hydroxydecanoic acid, and 9,10-epoxy−1-hydroxyoctadecanoic acid;
the epoxidized ester of the unsaturated long-chain fatty acid is an alkyl ester of epoxidized unsaturated fatty acid.

12. The coating material according to claim 10, wherein:
the epoxidized fatty acid ester is an epoxidized fatty oil, an epoxidized unsaturated fatty acid or an epoxidized ester of an unsaturated long-chain fatty acid;
the epoxidized fatty oil is at least one member selected from a group consisting of epoxy soybean oil, epoxy corn oil, epoxy castor oil, epoxy cottonseed oil, epoxy hemp seed oil, epoxy tall oil, epoxy safflower seed oil, epoxy peanut oil, epoxy flaxseed oil, and epoxy rapeseed oil;
the epoxidized unsaturated fatty acid is at least one member selected from a group consisting of 5,6-epoxy decanoic acid, 9,10-epoxy ricinoleic acid, 9,10-epoxy stearic acid, 4,5-epoxy decanoic acid, 9,10-epoxy octadecanoic acid, 9,10-epoxy tetracarboxylic acid, 8,9-epoxy-1-hydroxydecanoic acid, and 9,10-epoxy-1-hydroxyoctadecanoic acid;
the epoxidized ester of the unsaturated long-chain fatty acid is an alkyl ester of epoxidized unsaturated fatty acid.

13. The coating material according to claim 7, wherein:
in the step (1), a mass percentage of the esterification catalyst accounts for 0.2-0.8% of a total reactant which consists of the lactic acid, the bio-based alcohol and the esterification catalyst;
the esterification catalyst is an organo-titanate catalyst, an organotin catalyst, calcium oxide or zinc acetate;
the organo-titanate catalyst is isopropyl titanate or butyl titanate.

14. The coating material according to claim 8, wherein:
in the step (1), a mass percentage of the esterification catalyst accounts for 0.2-0.8% of a total reactant which consists of the lactic acid, the bio-based alcohol and the esterification catalyst;
the esterification catalyst is an organo-titanate catalyst, an organotin catalyst, calcium oxide or zinc acetate;
the organo-titanate catalyst is isopropyl titanate or butyl titanate.

15. The coating material according to claim 7, wherein a hydroxyl value of the bio-base polyol is in a range of 120 to 350 mgKOH/g, and a mass percentage of bio-based materials in all raw materials is in a range of 90% to 100%.

16. The coating material according to claim 8, wherein a hydroxyl value of the bio-base polyol is in a range of 120 to 350 mgKOH/g, and a mass percentage of bio-based materials in all raw materials is in a range of 90% to 100%.

17. A polyurethane controlled release fertilizer, which comprises fertilizer granules and a polyurethane controlled release fertilizer coating wrapped on a surface of each of the fertilizer granules, wherein the polyurethane controlled release fertilizer coating is prepared by curing the fully bio-based coating material according to claim 1 for the polyurethane controlled release fertilizer on the surface of the each of the fertilizer granules.
